(19) United States
(12) Patent Application Publication
(10) Pub. No.: US 2017/0237874 A1
(43) Pub. Date: Aug. 17, 2017

(54) SYSTEM AND METHOD OF ENABLING ACCESS TO LOCATION OF AN IMAGE

(71) Applicant: Tariq Tony Ghanma, Santa Clara, CA (US)

(72) Inventor: Tariq Tony Ghanma, Santa Clara, CA (US)

(21) Appl. No.: 15/434,050

(22) Filed: Feb. 15, 2017

Related U.S. Application Data
(60) Provisional application No. 62/295,861, filed on Feb. 16, 2016.

(51) Int. Cl. H04N 1/32; H04N 1/00; H04B 1/38

(52) U.S. Cl. CPC H04N 1/32272; H04B 1/38; H04N 1/00244; H04N 1/00103; H04M 2250/10; H04N 2201/3253; H04N 2201/0084

(57) ABSTRACT

The invention is a system and use method for associating an image being captured with its GPS location coordinates, then using the associated coordinates to pinpoint the image's location with a navigation application.

### TECHNICAL FIELD

System and method using mobile devices for storing, retrieving, and sharing images having an embedded marker encoding the location of that image.

### BACKGROUND OF THE INVENTION

Many mobile devices, smartphones in particular, are operative to capture images, to engage with GPS systems so as to capture GPS coordinates of a phone's current location, and to convey wirelessly captured image data. In conjunction with navigation applications, mobile devices can provide directions based on street and address numbers starting with a mobile device's current location coordinates. However, in the absence of street and number reference, navigation systems cannot currently provide directions. The invention herein disclosed and claimed makes use of subsystems commonly found in mobile devices to use a captured image as a navigation reference for the purpose of directing a user to the location of that image.

### BRIEF SUMMARY OF THE INVENTION

An image captured by a mobile device is rendered as bits representing picture elements in terms of brightness and color. Unless a user appends location information to a photo captured and shared, a viewer of that photo has no location information associated with the photo image. However, appropriately programmed with an application, a mobile device, using its built-in GPS resources, can capture both an image and the location of the device taking that image. Having done so, the application can append that location information to the captured image so that a viewer equipped with a complementary application capability can receive both the image and its location information. There are many uses for same. The underlying system that supports this capability comprises the mobile device's GPS subsystem, its camera subsystem, and cellular radio subsystem. In conjunction with an application program, the mobile device is capable of capturing the image using its camera subsystem, capturing the location data using its GPS subsystem, combining both the image data and location data, and then conveying that image/location data wirelessly to a server operative to store and provide authorized access to that image and its location data.

### BRIEF DESCRIPTIONS OF THE DRAWINGS

FIG. 1 depicts a system comprising a mobile device, a wireless networking environment, an internet, and a server device.

FIG. 2 is a flow depicting one embodiment whereby a mobile device, using its internal resources, captures image and location coordinates, appends that information to the image data, and conveys it to a server where it is stored and accessible.

FIG. 3 is a flow depicting an embodiment whereby a user uploads a photo and the system processes the image and location data to produce a marked image that combines both.

FIG. 4 is a flow depicting an embodiment whereby a website makes use of the embodiment of FIGS. 2 and 3 to serve a user with navigation directions based on the user's current location and the image's location information.

### DETAILED DESCRIPTION OF THE INVENTION

Navigation systems operate by associating GPS coordinates with map locations indexed by street number, name, city, state and country. When one enters a desired destination's location information (i.e. street number, name, etc.) it is processed and converted to GPS coordinates. Using the starting GPS coordinates determined by GPS satellite reception and processing, and the destination coordinates, a navigation system can then map out a route for getting from start to destination.

In the absence of map indexed street number, name, city and so on, one would need to know the GPS coordinates of the destination in order to provide a navigation system with sufficient input data. Currently there is no system and method for doing so.

Using a mobile device comprising a camera, GPS receiving subsystem, and a means for conveying data to the Internet one could, with the appropriate programming, create a way for capturing an image at any location and quickly associating it with its GPS coordinates. Note that unlike current navigation systems, the image's location coordinates do not require associating the image with a street number, name, city and so on. It is only necessary for the mobile device capturing that image to have the capability to receive GPS satellite data and use same to generate the coordinates.

In essence, most smartphones produced since 2013, have the subsystems needed for capturing an image, determining the image's GPS coordinates, combining that information, and conveying it via a wireless network infrastructure.

With this capability at hand, an individual can capture an image and associate it with its GPS coordinates. Media organizations (e.g. television, online, or print) can associate images they display with image-location GPS coordinates. The scope of users and use cases is extremely large.

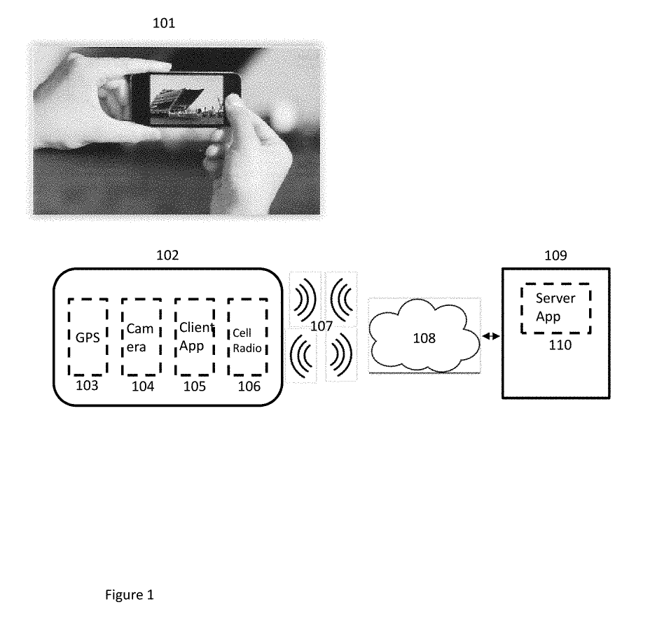

FIG. 1 depicts a user capturing an image of a nearby location using a mobile device (101). An exemplary mobile device (102) comprises a GPS subsystem (103), a camera subsystem (104), a program, such as a client application (105), and a cellular radio transceiver (106). A bidirectional wireless channel (107) is established between the mobile device (102) and an Internet infrastructure (108). Via that Internet infrastructure, data from the mobile device (102) is conveyed to a server (109) and processed by a server application (110). The subsystems within the mobile device, the wireless network infrastructure, Internet infrastructure, and server, including the client and server application programs constitute an exemplary invention system.

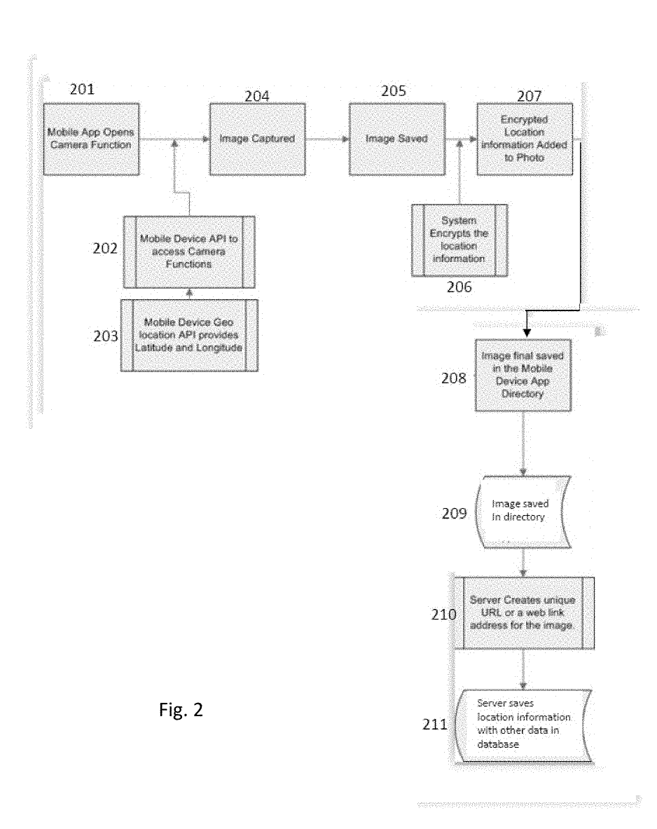

FIG. 2 is an exemplary flow diagram showing how a client application on a mobile device would associate a captured image with that location's GPS coordinates. The client application, a mobile application, initiates the camera function (201). The GPS system on the mobile device provides latitude and longitude GPS coordinates (203) which provide same to the mobile device (202). The image is captured (204) and saved (205). In this embodiment, the mobile device system encrypts the location information (206) and adds that information to the photo image data (207). The image/location data is saved in the mobile device (208) and the image with the encrypted location data is uploaded via the Internet to the application server (209). Using the server application, a unique URL or web link is created for the image (210), and the server saves the image and its location information in a database (211).

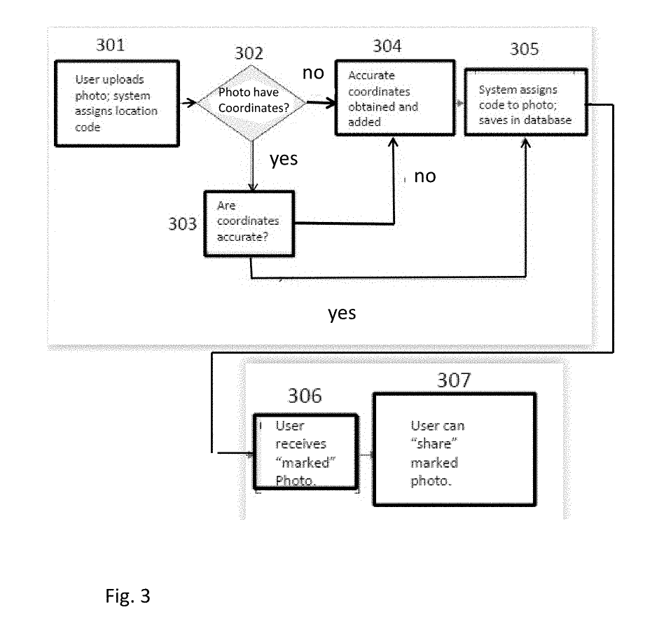

FIG. 3 is an exemplary flow diagram showing one embodiment of how the server processes the uploaded image photo. As shown, a user uploads a photo (301) and the server determines the presence (302) and accuracy (303) of the location data. If accuracy is below some standard limit, the server obtains accurate coordinates (304), otherwise the system assigns a code to the photo representing the encrypted location coordinates (305). The photo image is thus considered “marked” (306) and the code is considered a “marker.” The marked photo image can now be shared by the user (307).

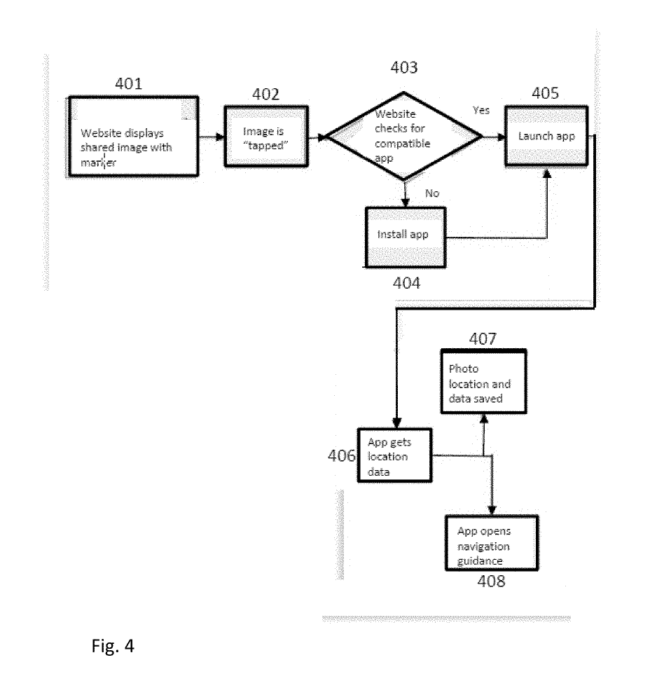

FIG. 4 is an exemplary flow diagram showing one embodiment for how a website processes a marked image. As shown, the website would display the marked image (401). If a website user then taps (i.e. selects) that displayed image (402), the website checks to see if the user has a compatible application. If so, the application is launched (405), if not, the website prompts the user to install the application (404) then launches it (405). The application decrypts the location data of the tapped image (406), and the image and location are saved (407). Concurrently, the application launches an appropriate navigation application (408) which uses the location data to process navigation directions.

The flow diagrams are exemplary and should not be read as limiting the scope of the application to just the functions shown. The displayed image may have the encrypted location information embedded in the image such that when scanned and processed by a client or server application, it can be decrypted and used by a navigation application. For purposes of identification, the embedded marker may be denoted by a small icon that a user will recognize as indicative of a marked image, that is, an image with associated location information.

The encryption/decryption process can be optional. That is, the location coordinates could be kept in clear-text format obviating the encryption/decryption step. That said, encryption/decryption allows for both privacy and exclusivity.

What is claimed is:

1. A system comprising:
a GPS subsystem operative to receive satellite signals and determine the position and the longitude and latitude coordinates of said position of said GPS subsystem;
a camera subsystem operative to capture an image, display said image, and represent said image using digital representation of the picture elements of said image;
a storage subsystem operative to store said digital representation of said image;
a wireless transceiver operative to transmit and receive wireless signals;
said wireless signals conveyed to and from a wireless network;
said wireless network operative to access and convey signal data to and from an internet;
said internet operative to convey data to and from a server system;
a first application program operative to obtain said longitude and latitude coordinates of said GPS subsystem's location;
said first application program operative to obtain said digital representation of said image;
said first application program operative to associate said longitude and latitude coordinates with said digital representation of said image;
a second application program operative to obtain said associated longitude and latitude coordinates with said digital representation of said image, conveyed to said server system, and to index and store said associated longitude and latitude coordinates with said digital representation.

2. A system as in claim 1 further comprising:
said first application program encrypts said longitude and latitude coordinates prior to associating same with said digital representation of said image.

3. A system comprising:
said GPS subsystem operative to receive said satellite signals and determine said position and said longitude and latitude coordinates of said position of said GPS subsystem;
said camera subsystem operative to capture said image, display said image, and represent said image using said digital representation of said picture elements of said image;
said storage subsystem operative to store said digital representation of said image;
said wireless transceiver operative to transmit and receive said wireless signals;
said wireless signals conveyed to and from said wireless network;
said wireless network operative to access and convey signal data to and from an internet;
said internet operative to convey data to and from said server system;
said second application program operative to convey said associated longitude and latitude coordinates to a user system when user is viewing said image displayed by said camera subsystem and selected by said user;
said first application program operative to convey said associated longitude and latitude coordinates of said image to a navigation program as destination location coordinates;
said first application program operative to convey said position and said longitude and latitude coordinates of said position of said GPS subsystem to said navigation program as embarkation location coordinates.

4. A system as in claim 3 further comprising:
said second application program decrypts said longitude and latitude coordinates prior to associating same with said digital representation of said image;
said second application program operative to convey said decrypted associated longitude and latitude coordinates to said user system when said user is viewing said image display by said camera subsystem and selected by said user.

5. A use method comprising:
initiating camera function;
determining GPS coordinates of camera;
capturing an image;
saving said image to a directory;
combining said image data with said GPS coordinates data;
creating a unique URL for said image and its said GPS coordinates data;
saving said unique URL in server database.

6. A use method as in claim 5 further comprising:
encrypting said GPS coordinates prior to saving said combined image data with GPS coordinate data.

7. A use method comprising:
receiving uploaded said image data;
determining if said image data is accompanied by coordinates data;
if so, determining if said coordinates data is sufficiently accurate;
if not, obtaining said sufficiently accurate coordinates data;
encoding said coordinates data;
assigning said encoded coordinates data to said image data;
marking said image data with said encoded coordinates data;
returning said marked image data to a user;
sharing by said user of said marked image data.

8. A use method comprising:
displaying by a website said marked image;
selecting said marked image;
determining if compatible application is installed;
if so, launching compatible application;
if not, installing then launching said compatible application;
obtaining said longitude and latitude coordinates by said compatible application;
saving said image and said longitude and latitude coordinates associated with said image;
using said longitude and latitude coordinates as said destination location data.
